(19) United States
(12) Patent Application Publication
(10) Pub. No.: US 2026/0323587 A1
(43) Pub. Date: Oct. 15, 2026

(54) BLUETOOTH POSITIONING METHOD AND SYSTEM, AND BLUETOOTH DEVICE

(71) Applicant: Alipay (Hangzhou) Digital Service Technology Co., Ltd., Hangzhou (CN)

(72) Inventor: Fuhu LIU, Hangzhou (CN)

(21) Appl. No.: 19/686,219

(22) Filed: May 22, 2026

Related U.S. Application Data
(63) Continuation of application No. PCT/CN2024/127008, filed on Oct. 24, 2024.

(30) Foreign Application Priority Data
Dec. 14, 2023 (CN) 202311721624.8

(51) Int. Cl. H04W 64/00; H04W 12/03; H04W 12/041; H04W 12/0431; H04W 12/50; H04W 76/14

(52) U.S. Cl. CPC H04W 64/003; H04W 12/03; H04W 12/041; H04W 12/0431; H04W 12/50; H04W 76/14

(57) ABSTRACT

An implementation of the present application discloses a Bluetooth positioning method, including: binding a first device to at least one second device, by a positioning APP of the first device; broadcasting, by the second device, a Bluetooth signal; performing, by the first device, positioning to obtain location information in response to identifying the Bluetooth signal through scanning; uploading, by the first device, the location information to a distributed storage center; and in response to an operation of searching for the second device by a user in the positioning APP, obtaining, by the positioning APP, the location information from the distributed storage center through an APP server, and using the location information as location information of the second device. The method provides an open positioning solution, which is not limited to a specific terminal or APP, so that the Bluetooth positioning method can be applied to more scenarios. The system and the device described in the implementations of the present application also have the above beneficial effects.

### CROSS-REFERENCE TO RELATED APPLICATION

The present application is a continuation of PCT Application No. PCT/CN2024/127008, file don Oct. 24, 2024, which claims priority benefit to Chinese Patent Application No. 202311721624.8, filed on Dec. 14, 2023, which are all incorporated herein by reference in their entirety for all purposes.

### BACKGROUND

A general positioning solution of current IoT devices is integrating a GPS module and a network module. The GPS module performs positioning and the network module reports data. The two modules have high hardware costs and high energy consumption, and need network traffic support, and therefore are more widely used in high-priced devices. A low-cost device that includes only a Bluetooth module lacks an effective positioning solution due to lack of a positioning capability.

### SUMMARY

One or more implementations of the present specification provide a Bluetooth positioning method and system, and a Bluetooth device, which, among others, provide an effective positioning solution for a device that includes only a Bluetooth module.

According to a first aspect, a Bluetooth positioning method is provided, and includes: binding a first device to at least one second device, by a positioning APP of the first device, where the positioning APP is installed on the first device; broadcasting, by the second device, a Bluetooth signal; performing, by the first device, positioning to obtain location information in response to identifying the Bluetooth signal through scanning; uploading, by the first device, the location information to a distributed storage center; and in response to an operation of searching for the second device by a user in the positioning APP, obtaining, by the positioning APP, the location information from the distributed storage center through an APP server, and using the location information as location information of the second device.

In an example implementation, the binding the first device to the at least one second device, by the positioning APP of the first device includes: performing Bluetooth pairing between the first device and a second device; after the pairing succeeds, generating, by the positioning APP, a public key and a private key that match each other; storing, by the positioning APP, the private key in the first device, and sending the public key to the second device through the first device; and storing, by the second device, the public key.

In an example implementation, the Bluetooth signal can include a device identifier of the second device and the public key.

In an example implementation, the uploading, by the first device, the location information to the distributed storage center includes: encrypting, by the first device, the location information by using the public key included in the Bluetooth signal, to obtain first encrypted information; uploading, by the first device, the first encrypted information to a device server; performing, by the device server, secondary encryption on the first encrypted information by using an encryption key, to obtain second encrypted information; and uploading, by the device server, the second encrypted information to the distributed storage center.

For example, the obtaining, by the positioning APP, the location information from the distributed storage center through the APP server includes: sending, by the positioning APP, a query request to the APP server; querying, by the APP server, the second encrypted information in the distributed storage center in response to the query request; sending, by the APP server, the second encrypted information to the device server; decrypting, by the device server, the second encrypted information by using a decryption key, and returning the obtained first encrypted information to the APP server; sending, by the APP server, the first encrypted information to the positioning APP; and decrypting, by the positioning APP, the first encrypted information by using the private key stored in the first device, to obtain the location information.

For example, the querying, by the APP server, the second encrypted information in the distributed storage center in response to the query request includes: querying, by the APP server, the second encrypted information in the distributed storage center based on the public key.

In an example implementation, the uploading, by the first device, the location information to the distributed storage center includes: encrypting, by the first device, the location information by using the public key included in the Bluetooth signal, to obtain first encrypted information; performing, by the first device, secondary encryption on the first encrypted information by using an encryption key of a device server, to obtain second encrypted information; and uploading, by the first device, the second encrypted information to the distributed storage center.

Correspondingly, the obtaining, by the positioning APP, the location information from the distributed storage center through the APP server includes: sending, by the positioning APP, a query request to the APP server; querying, by the APP server, the second encrypted information in the distributed storage center in response to the query request; sending, by the APP server, the second encrypted information to the device server; decrypting, by the device server, the second encrypted information by using a decryption key, and returning the obtained first encrypted information to the APP server; sending, by the APP server, the first encrypted information to the positioning APP; and decrypting, by the positioning APP, the first encrypted information by using the private key stored in the first device, to obtain the location information.

For example, the querying, by the APP server, the second encrypted information in the distributed storage center in response to the query request includes: querying, by the APP server, the second encrypted information in the distributed storage center based on the public key.

In an example implementation, the method further includes: after the binding the first device to the at least one second device, by the positioning APP of the first device, displaying, on a device management interface of the positioning APP, at least one second device bound to the first device.

According to a second aspect, a Bluetooth device is provided, and includes a processor and a communication interface. The communication interface is configured to exchange information between the Bluetooth device and another Bluetooth device. When program instructions are executed in the at least one processor, the Bluetooth device interacts with the another Bluetooth device as a first device, to implement the Bluetooth positioning method.

According to a third aspect, a Bluetooth positioning system is provided, and includes a distributed storage center, a first device, and at least one second device. A positioning APP is installed on the first device. Information is exchanged between the first device and the second device through Bluetooth, to implement the Bluetooth positioning method.

A technical effect of the Bluetooth positioning method described in the one or more implementations of the present specification is that a decentralized Bluetooth positioning solution is provided, so that the technical solution is not limited to a specific terminal or APP, and a to-be-positioned Bluetooth device can be an independent hardware device, or can be integrated into hardware of an existing article as a functional module, so that the Bluetooth positioning method can be applied to more scenarios.

The Bluetooth positioning system and the Bluetooth device described in the implementations of the present specification also have the above beneficial effects.

### BRIEF DESCRIPTION OF DRAWINGS

To describe the technical solutions in the implementations of the present specification or in the related technologies more clearly, the following is a brief introduction of the accompanying drawings for illustrating such technical solutions. Clearly, the accompanying drawings described below are some implementations of the present specification, and a person of ordinary skill in the art can derive other drawings from such accompanying drawings without making creative efforts.

FIG. 1 is a schematic flowchart illustrating a Bluetooth positioning method according to some implementations of the present application;

FIG. 2 is a schematic diagram illustrating a Bluetooth positioning system according to some implementations of the present application;

FIG. 3 is a schematic flowchart illustrating a Bluetooth positioning method implemented based on the Bluetooth positioning system shown in FIG. 2 according to some implementations of the present application;

FIG. 4 is a schematic diagram illustrating a Bluetooth positioning system according to some other implementations of the present application;

FIG. 5 is a schematic flowchart illustrating a Bluetooth positioning method implemented based on the Bluetooth positioning system shown in FIG. 4 according to some implementations of the present application; and

FIG. 6 is a schematic structural diagram illustrating a Bluetooth device according to some implementations of the present application.

### DESCRIPTION OF EMBODIMENTS

A general positioning solution of current IoT devices integrates a GPS module and a network module. The GPS module performs positioning and the network module transmits data. The two modules have high hardware costs and high energy consumption, and need network traffic support, and therefore are more widely used in high-priced devices, such as mobile phones, phone watches, and four-wheel vehicles. A low-cost device that includes only a short range wireless communication module, e.g., a Bluetooth module or a near-field communication module. For example, a battery-powered car that integrates a Bluetooth digital key, typically lacks an effective positioning solution due to lack of a positioning capability.

In view of this, one or more implementations of the present specification provide a Bluetooth positioning method and system, and a Bluetooth device, to provide an efficient and accurate positioning solution for a device that has a Bluetooth function, especially a device that includes only a Bluetooth module.

To enable a person skilled in the art to better understand the technical solutions in the present specification, the following clearly and completely describes the technical solutions in the implementations of the present specification with reference to the accompanying drawings in the implementations of the present specification. Clearly, the described implementations are merely some rather than all of the implementations of the present specification. All other implementations obtained by a person of ordinary skill in the art based on the implementations of the present specification without making innovative efforts shall fall within the protection scope of the present specification.

It should be noted that, in other implementations, the acts of the corresponding method are not necessarily performed in the sequence shown and described in the present specification. In some other implementations, the method can include more or fewer acts than those described in the present specification. In addition, a single act described in the present specification can be broken down into a plurality of acts in other implementations for description, and a plurality of acts described in the present specification can be combined into a single act in other implementations for description.

A person skilled in the art can understand that the term used in the implementations of the present specification is merely for the purpose of describing a specific implementation, and is not intended to limit the present specification. The terms “a”, “the”, and “this” of singular forms used in the implementations of the present specification and the appended claims are also intended to include plural forms, unless otherwise specified in the context clearly.

In the description herein, Bluetooth is used as an example to describe the technical solutions of the specification. It should be appreciated that implementations of the specification may also use or be similarly achieved through other short range wireless communication technologies such as near-field communication (NFC), Wi-Fi, Zigbee or Z-Wave, Ultra-Wideband (UWB), radio frequency identification (RFID), which are all included in the scope of the specification.

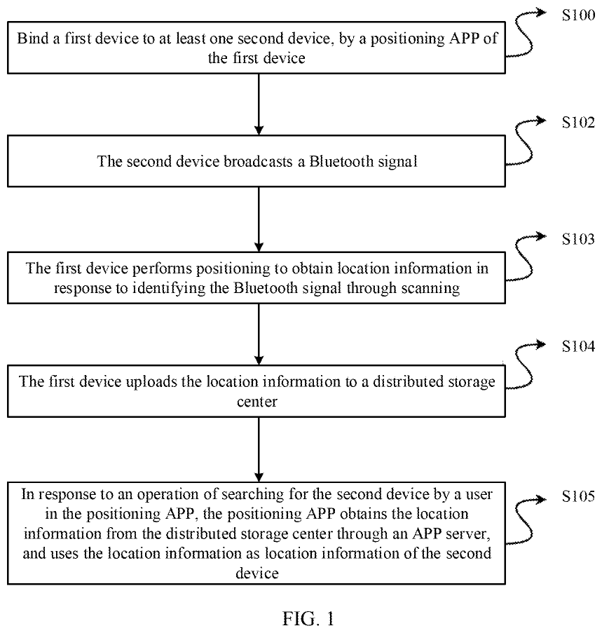

One or more implementations of the present specification provide a positioning method based on short range wireless communication (briefly referred to as a positioning method herein). Referring to FIG. 1, FIG. 1 shows an example of a schematic flowchart illustrating the Bluetooth positioning method. A procedure of the positioning method includes act S100 to act S108.

S100: Bind a first device to at least one second device, by a positioning APP of the first device.

The first device has a Bluetooth function and a positioning function, and the positioning APP is installed on the first device. For example, the first device can be an electronic device that integrates a Bluetooth module with a Bluetooth function and a positioning module with a positioning function. For example, the first device can be a smartphone, a terminal device in an industrial computer, a tablet computer, or a wearable device. The electronic device can run the positioning APP, and display a user interaction interface (for example, a device management interface) of the positioning APP. A user can perform location search on a bound second device through the user interaction interface of the positioning APP. For example, the bound second device is displayed on the device management interface. The user can tap a search button of each second device to implement location search for the second device. The identified location information can be displayed on the device management interface in a one-to-one correspondence with the second device.

The second device has at least a Bluetooth function. The second device can be an independent hardware device with a Bluetooth function, for example, a Bluetooth label, or can be a device that integrates a Bluetooth module with a Bluetooth function, for example, a Bluetooth headset, a vehicle-mounted terminal that integrates a Bluetooth module, or a digital vehicle key that integrates a Bluetooth module.

The first device and the second device can be in a one-to-one correspondence or can be in a one-to-many relationship. For example, the first device can be bound to only one second device, or can be bound to a plurality of second devices. This is not limited in this implementation.

In some implementations, an example process of binding the first device to the at least one second device can include the following acts.

First, Bluetooth pairing is performed between the first device and the second device. After the pairing succeeds, the positioning APP generates a public key and a private key that match each other. The positioning APP stores the private key in the first device, and sends the public key to the second device through the first device. The second device stores the public key.

For example, in a Bluetooth pairing and key distribution process, pairing and binding can be performed between the second device and the first device by using the BLE protocol, including three phases:
Phase 1: The first device and the second device perform pairing feature exchange, to obtain a temporary key (TK).
Phase 2: Perform identity authentication between the first device and the second device by using the TK, and after the authentication is completed, perform pairing by using the security management protocol (SMP), and generate a short-term key (STK).
Phase 3: The first device and the second device perform secure communication by using the STK, and negotiate a long-term key. For example, the positioning APP can generate a public/private key pair based on the STK by using an elliptic algorithm.

It should be noted that a public key of the second device should be unique, e.g., each second device has a public key that is different from that of another second device, and the first device stores a private key of each second device.

S102: The second device broadcasts a Bluetooth signal.

In some implementations, to ensure confidentiality of user data privacy, the second device can include a public key during broadcasting. For example, the Bluetooth signal broadcast by the second device can include a device identifier and public key information of the second device.

For example, the second device can broadcast the public key information and the device identifier (for example, a vendor and a device type) in the BLE protocol. A length of the public key is 28 bytes, and a maximum length of a Bluetooth broadcast packet is 31 bytes. In addition, 4 bytes are required for identifying the vendor and the type during broadcasting. Considering that a broadcast packet length is insufficient, during broadcasting, the second device can generate a MAC address by using first six bits of the public key, and the remaining 22 bytes form the broadcast signal together with device identification information such as a vendor and a device type.

S104: The first device performs positioning to obtain location information in response to identifying the Bluetooth signal through scanning.

When identifying the Bluetooth signal through scanning, the first device can determine, based on the device identifier included in the Bluetooth signal, whether the Bluetooth signal is from a bound second device. If the Bluetooth signal is from the bound second device, the first device positions a location of the first device by using a positioning module of the first device to obtain the location information. The positioning module can be a GPS module.

S106: The first device uploads the location information to a distributed storage center.

The distributed storage center is a device cluster including a plurality of storage servers. In the distributed storage center, the location information can be stored in a form of a key value pair, e.g., when storing the location information in the distributed storage center, the first device stores the location information data in a form of key-value. The key can be used to indicate a device identifier of a sender of the Bluetooth signal that triggers the first device to obtain the location information, e.g., a device identifier of a corresponding second device, and the value is used to indicate location information or is used to indicate a storage location of the location information in a storage table of the distributed storage center. In addition to a storage form of the key value pair, the location information can be stored in another form in the distributed storage center. This is not limited in this implementation.

It should be understood that the location information stored in the distributed storage center has a unique index. A positioning server of the positioning APP can retrieve corresponding location information in the distributed storage center based on the index. The index can be retrieved based on a unique identifier of the second device. For example, a hash algorithm can be used to map the public key or partial information of the public key of the second device to the index. As such, during retrieval, corresponding location information can be retrieved based on the public key information of the second device.

S108: In response to an operation of searching for the second device by a user in the positioning APP, the positioning APP obtains the location information from the distributed storage center through an APP server, and uses the location information as location information of the second device.

After the second device is bound, the second device bound to the first device can be displayed on a device management interface of the positioning APP of the first device. The user can select the second device that needs to be positioned from the device management interface, and trigger the first device to perform positioning.

For example, after the user performs a selection operation on the to-be-positioned second device on the device management interface, the positioning APP generates a query request and sends the query request to the APP server. The query request can include a unique identifier of the second device, so that the APP server can retrieve corresponding location information from the distributed storage center based on the unique identifier.

The location information retrieved by the APP server is actually location information of the first device. However, considering that a communication distance of Bluetooth communication is very short, when the first device identifies, through scanning, the Bluetooth signal sent by the second device, the second device maintains a very limited distance from the first device. Therefore, in this case, the location information of the first device can be used to roughly indicate the location information of the second device.

The APP server can send the location information to the positioning APP, so that the positioning APP displays the location information to the user.

The above positioning method provides a decentralized Bluetooth positioning solution, so that the entire solution is not limited to a specific terminal or APP, and a to-be-positioned Bluetooth device can be an independent hardware device, or can be integrated into hardware of an existing article as a functional module, so that the Bluetooth positioning method can be applied to more scenarios.

The following further describes the above positioning method with reference to a specific application scenario.

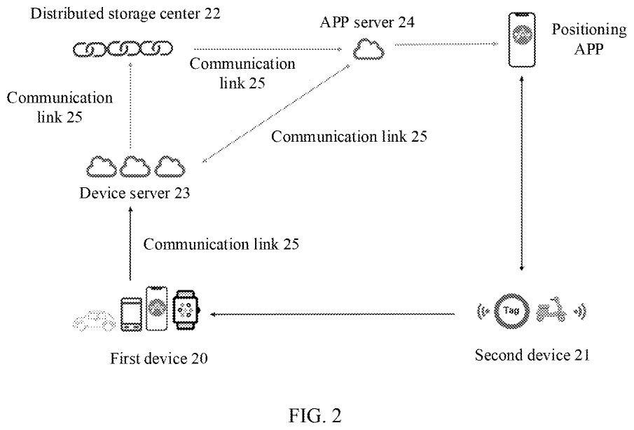

Referring to FIG. 2, FIG. 2 shows a Bluetooth positioning system, which can be used to implement the Bluetooth positioning method. It should be noted that the Bluetooth positioning method described in one or more implementations of the present application can be implemented by using the Bluetooth positioning system shown in FIG. 2, but is not limited to the Bluetooth positioning system.

As shown in FIG. 2, the Bluetooth positioning system includes a first device 20, a second device 21, a distributed storage center 22, a device server 23, and an APP server 24. A connection is established between the first device 20 and the second device 21 through Bluetooth. A connection is established between the first device 20 and the device server 23 through a communication link 25, a connection is established between the device server 23 and the distributed storage center 22 through a communication link 25, a connection is established between the device server 23 and the APP server through a communication link 25, and a connection is established between the distributed storage center 22 and the APP server 24 through a communication link 25.

The first device 20 can be implemented by using an intelligent device such as but not limited to a smartphone, a notebook computer, and a tablet device. A positioning APP is installed on the first device 20, to provide an interaction interface of the Bluetooth positioning method for a user.

The second device 21 can be an independent hardware device that has a Bluetooth function, or can be a Bluetooth module integrated into the device, for example, a Bluetooth AP.

The device server 23 is a server provided by a vendor of the first device 20, and can be any apparatus, device, platform, or device cluster that has a computing and processing capability. In this implementation, an implementation form of the device server 23 is not limited. For example, the device server 23 can be a single server, or can be a server cluster including a plurality of servers. The device server 23 can alternatively be a cloud server, which is also referred to as a cloud computing server or a cloud host, and is a host product in a cloud computing service system.

The APP server 24 is a server provided by a service provider of the positioning APP. Similarly, the APP server 24 can be any apparatus, device, platform, or device cluster that has a computing and processing capability. In this implementation, an implementation form of the APP server 24 is not limited. For example, the APP server 24 can be a single server, or can be a server cluster including a plurality of servers. The APP server 24 can alternatively be a cloud server, which is also referred to as a cloud computing server or a cloud host, and is a host product in a cloud computing service system.

The communication link 25 can be implemented through a communication interface disposed on the first device 20, the distributed storage center 22, the device server 23, and the APP server 24. The communication interface can be a transceiver module such as but not limited to a network interface card and a transceiver to implement communication between the first device 20, the distributed storage center 22, the device server 23, and the APP server 24.

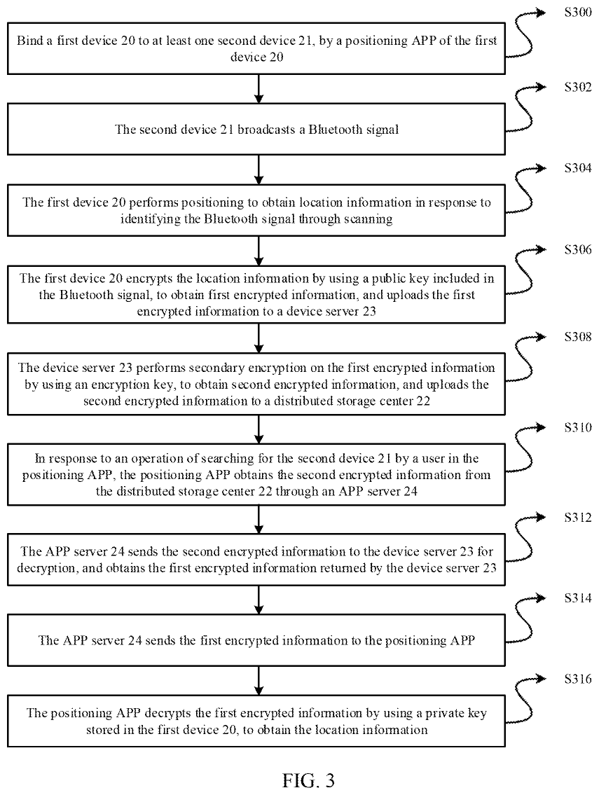

Referring to FIG. 3, a procedure of a Bluetooth positioning method implemented based on the Bluetooth positioning system shown in FIG. 2 includes act S300 to act S316.

S300: Bind a first device 20 to at least one second device 21, by a positioning APP of the first device 20.

For example, a process of binding the first device 20 to the second device 21 is as follows: Bluetooth pairing is performed between the first device 20 and the second device 21; after the pairing succeeds, the positioning APP generates a public key and a private key that match each other; the positioning APP stores the private key in the first device 20, and sends the public key to the second device 21 through the first device 20; and the second device 21 stores the public key.

S302: The second device 21 broadcasts a Bluetooth signal.

After obtaining the public key, the second device 21 broadcasts the Bluetooth signal, where the Bluetooth signal includes a device identifier of the second device 21 and the public key.

S304: The first device 20 performs positioning to obtain location information, e.g., of the first device 20, in response to identifying the Bluetooth signal through scanning.

After identifying the Bluetooth signal through scanning, the first device 20 can determine, based on the device identifier included in the Bluetooth signal, whether the Bluetooth signal is from a bound second device 21. If the Bluetooth signal is from the bound second device 21, the first device 20 performs positioning to obtain the location information of the first device 20 at this time.

S306: The first device 20 encrypts the location information by using the public key included in the Bluetooth signal, to obtain first encrypted information, and uploads the first encrypted information to a device server 23.

S308: The device server 23 performs secondary encryption on the first encrypted information by using an encryption key, to obtain second encrypted information, and uploads the second encrypted information to a distributed storage center 22.

The device server 23 can pre-store an encryption key and a decryption key, or can be a key generation apparatus, to generate an encryption key and a decryption key each time the first encrypted information is obtained.

The device server 23 can encrypt the first encrypted information by using the pre-stored encryption key or an encryption key generated in real time, to obtain the second encrypted information.

The device server 23 uploads the second encrypted information to the distributed storage center 22. The distributed storage center 22 can store the second encrypted information, and build an index. The index can be related to a public key corresponding to the second encrypted information, so that the second encrypted information can be retrieved based on the public key of the second device 21 during later retrieval. For example, the index can be unique code mapped from all or part of information of the public key.

S310: In response to an operation of searching for the second device 21 by a user in the positioning APP, the positioning APP obtains the second encrypted information from the distributed storage center 22 through an APP server 24.

For example, the positioning APP sends a query request to the APP server 24 based on the operation of performing searching by the user. The APP server 24 queries the second encrypted information in the distributed storage center 22 in response to the query request.

In some implementations, the index of the second encrypted information in the distributed storage center 22 is generated by using a public key of a corresponding second device 21. Therefore, the APP server 24 can query the second encrypted information in the distributed storage center 22 based on the public key of the second device 21.

S312: The APP server 24 sends the second encrypted information to the device server 23 for decryption, and obtains the first encrypted information returned by the device server 23.

Because the second encrypted information is obtained by the device server 23 through encryption by using an encryption key, the device server 23 can decrypt the second encrypted information by using a matching decryption key, to obtain the first encrypted information, and then return the obtained first encrypted information to the APP server 24.

S314: The APP server 24 sends the first encrypted information to the positioning APP.

S316: The positioning APP decrypts the first encrypted information by using the private key stored in the first device 20, to obtain the location information.

The first device 20 stores the private key that matches the public key included in the Bluetooth signal. The first encrypted information encrypted by using the public key can be decrypted by using the private key, to obtain the location information.

After obtaining the location information, the positioning APP can display the location information on the device management interface.

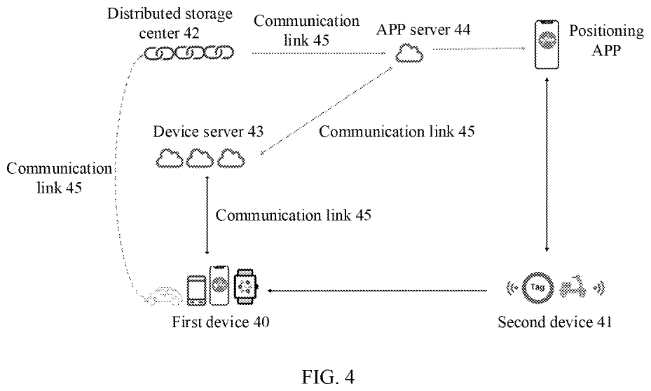

Referring to FIG. 4, FIG. 4 shows another Bluetooth positioning system, which can be used to implement the Bluetooth positioning method. It should be noted that the Bluetooth positioning method described in one or more implementations of the present application can be implemented by using the Bluetooth positioning system shown in FIG. 4, but is not limited to the Bluetooth positioning system.

As shown in FIG. 4, the Bluetooth positioning system includes a first device 40, a second device 41, a distributed storage center 42, a device server 43, and an APP server 44. A connection is established between the first device 40 and the second device 41 through Bluetooth. A connection is established between the first device 40 and the device server 43 through a communication link 45, a connection is established between the first device 40 and the distributed storage center 42 through a communication link 45, a connection is established between the device server 43 and the APP server through a communication link 45, and a connection is established between the distributed storage center 42 and the APP server 44 through a communication link 45.

The first device 40 can be implemented by using an intelligent device such as but not limited to a smartphone, a notebook computer, and an iPad. A positioning APP is installed on the first device 40, to provide an interaction interface of the Bluetooth positioning method for a user.

The second device 41 can be an independent hardware device that has a Bluetooth function, or can be a Bluetooth module integrated into the device, for example, a Bluetooth AP.

The device server 43 is a server provided by a vendor of the first device 40, and can be any apparatus, device, platform, or device cluster that has a computing and processing capability. In this implementation, an implementation form of the device server 43 is not limited. For example, the device server 43 can be a single server, or can be a server cluster including a plurality of servers. The device server 43 can alternatively be a cloud server, which is also referred to as a cloud computing server or a cloud host, and is a host product in a cloud computing service system.

The APP server 44 is a server provided by a service provider of the positioning APP. Similarly, the APP server 44 can be any apparatus, device, platform, or device cluster that has a computing and processing capability. In this implementation, an implementation form of the APP server 44 is not limited. For example, the APP server 44 can be a single server, or can be a server cluster including a plurality of servers. The APP server 44 can alternatively be a cloud server, which is also referred to as a cloud computing server or a cloud host, and is a host product in a cloud computing service system.

The communication link 45 can be implemented through a communication interface disposed on the first device 40, the distributed storage center 42, the device server 43, and the APP server 44. The communication interface can be a transceiver module such as but not limited to a network interface card and a transceiver to implement communication between the first device 40, the distributed storage center 42, the device server 43, and the APP server 44.

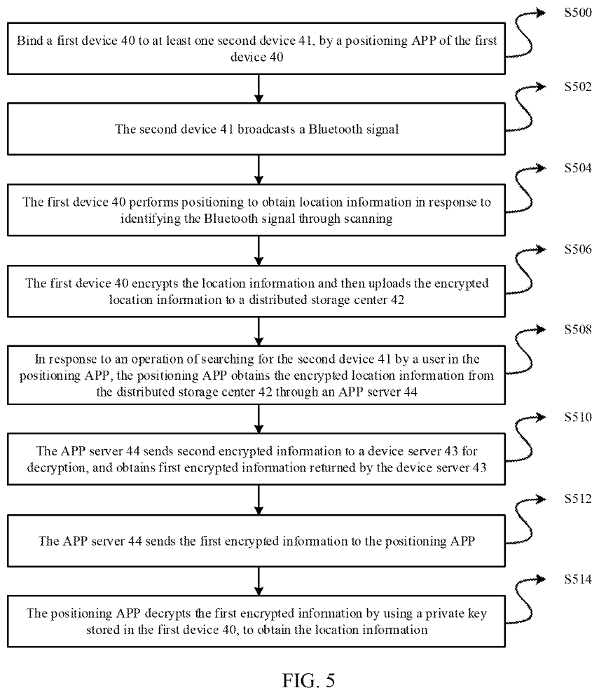

Referring to FIG. 5, a procedure of a Bluetooth positioning method implemented based on the Bluetooth positioning system shown in FIG. 4 includes act S500 to act S514.

S500: Bind a first device 40 to at least one second device 41, by a positioning APP of the first device 40.

For example, a process of binding the first device 40 to the second device 41 is as follows: Bluetooth pairing is performed between the first device 40 and the second device 41; after the pairing succeeds, the positioning APP generates a public key and a private key that match each other; the positioning APP stores the private key in the first device 40, and sends the public key to the second device 41 through the first device 40; and the second device 41 stores the public key.

S502: The second device 41 broadcasts a Bluetooth signal.

After obtaining the public key, the second device 41 broadcasts the Bluetooth signal, where the Bluetooth signal includes a device identifier of the second device 41 and the public key.

S504: The first device 40 performs positioning to obtain location information in response to identifying the Bluetooth signal through scanning.

After identifying the Bluetooth signal through scanning, the first device 40 can determine, based on the device identifier included in the Bluetooth signal, whether the Bluetooth signal is from a bound second device 41. If the Bluetooth signal is from the bound second device 41, the first device 40 performs positioning to obtain the location information of the first device 40 at this time.

S506: The first device 40 encrypts the location information and then uploads the encrypted location information to a distributed storage center 42.

For example, the first device 40 can encrypt the location information twice. For the first encryption, the location information can be encrypted by using the public key included in the Bluetooth signal, to obtain first encrypted information. For the second encryption, secondary encryption can be performed on the first encrypted information by using an encryption key of the device server 43, to obtain second encrypted information.

The first device 40 can pre-store the encryption key of the device server 43, and a corresponding decryption key is stored in the device server 43. After obtaining the location information, the first device 40 can further request to obtain an encryption key from the device server 43 in real time. The device server 43 can deliver the encryption key to the first device 40 based on the request, and store a corresponding decryption key.

The first device 40 uploads the second encrypted information to the distributed storage center 42. The distributed storage center 42 can store the second encrypted information, and build an index. The index can be related to a public key corresponding to the second encrypted information, so that the second encrypted information can be retrieved based on the public key of the second device 41 during later retrieval. For example, the index can be unique code mapped from all or part of information of the public key.

S508: In response to an operation of searching for the second device 41 by a user in the positioning APP, the positioning APP obtains the encrypted location information from the distributed storage center 42 through an APP server 44.

For example, the positioning APP sends a query request to the APP server 44 based on the operation of performing searching by the user. The APP server 44 queries the second encrypted information in the distributed storage center 42 in response to the query request.

In some implementations, the index of the second encrypted information in the distributed storage center 42 is generated by using a public key of a corresponding second device 41. Therefore, the APP server 44 can query the second encrypted information in the distributed storage center 42 based on the public key of the second device 41.

S510: The APP server 44 sends the second encrypted information to the device server 43 for decryption, and obtains the first encrypted information returned by the device server 43.

Because the second encrypted information is obtained through encryption by using an encryption key of the device server 43, the device server 43 can decrypt the second encrypted information by using a matching decryption key, to obtain the first encrypted information, and then return the obtained first encrypted information to the APP server 44.

S512: The APP server 44 sends the first encrypted information to the positioning APP.

S514: The positioning APP decrypts the first encrypted information by using the private key stored in the first device 40, to obtain the location information.

The first device 40 stores the private key that matches the public key included in the Bluetooth signal. The first encrypted information encrypted by using the public key can be decrypted by using the private key, to obtain the location information.

After obtaining the location information, the positioning APP can display the location information on the device management interface.

It can be learned from the above procedure that, in the Bluetooth positioning method described in this implementation, a decentralized and open Bluetooth positioning solution can be provided on the premise of protecting user privacy, so that requirements of a plurality of Bluetooth positioning scenarios can be satisfied.

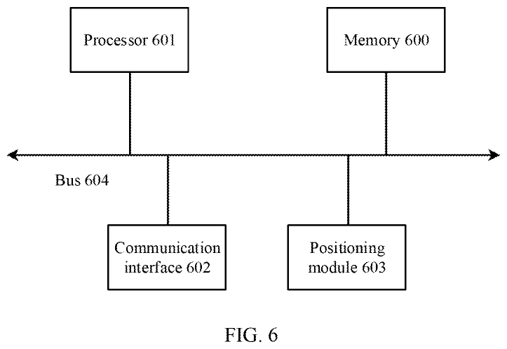

Referring to FIG. 6, this implementation further provides a Bluetooth device. The device includes a memory 600, a processor 601, a communication interface 602, a positioning module 603, and a bus 604. The positioning module 603 is configured to implement a positioning function of the device, and the communication interface 602 is configured to exchange information between the Bluetooth device and another Bluetooth device. When program instructions in the memory 600 are executed in the at least one processor 601, the Bluetooth device interacts with the another Bluetooth device as a first device, to implement the above Bluetooth positioning method.

It should be understood that numbers of processors 601 and memories 600 in the Bluetooth device are not limited in the present application.

The bus 604 can be a peripheral component interconnect (PCI) bus, an extended industry standard architecture (EISA) bus, or the like. The bus 604 can be classified into an address bus, a data bus, a control bus, and the like. For ease of representation, only one line is used to represent the bus in FIG. 6, but this does not mean that there is only one bus or only one type of bus. The bus 604 can include a path for transmitting information between components (for example, the memory 600, the processor 601, the communication interface 602, and the positioning module 603) of the Bluetooth device.

The memory 600 can include a volatile memory, such as a random access memory (RAM). The memory 600 can further include a non-volatile memory, such as a read-only memory (ROM), a flash memory, a hard disk drive (HDD), or a solid state drive (SSD).

The processor 601 can include any one or more of a central processing unit (CPU), a graphics processing unit (GPU), a microprocessor (MP), a digital signal processor (DSP), or the like.

The communication interface 602 is a transceiver module, such as but not limited to a network interface card and a transceiver, to implement communication between the Bluetooth device and another Bluetooth device or a communication network, for example, communication with a device server.

A computing apparatus, e.g., a server or a device, may include one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

A person skilled in the art should understand that the above modules or acts of the present specification can be implemented by using a general-purpose computing apparatus, and can be concentrated on a single computing apparatus or distributed on a network including a plurality of computing apparatuses. Optionally, the modules or acts can be implemented by using program code executable by the computing apparatus. Therefore, the modules or acts can be stored in a storage apparatus and executed by the computing apparatus. In addition, in some cases, the acts shown or described can be executed in an order different from herein, or the modules or acts can be separately fabricated into integrated circuit modules, or a plurality of modules or acts in the modules or acts are fabricated into a single integrated circuit module for implementation. As such, the present specification is not limited to any specific combination of hardware and software.

The implementations in the present specification are described in a progressive manner. For same or similar parts in the implementations, reference may be made to each other. Each implementation focuses on a difference from other implementations. Particularly, the system implementations include similar technical features as the method implementations, and therefore are described briefly. For related parts, references can be made to some descriptions of the method implementations.

The above describes a specific implementation of the present specification. Other implementations fall within the scope of the appended claims. In some cases, the actions or acts recorded in the claims can be performed in an order different from that in the implementations and the desired results can still be achieved. In addition, the process depicted in the accompanying drawings does not necessarily require the shown particular order or sequence to achieve the desired results. In some implementations, multi-task processing and parallel processing are possible or can be implemented.

It should be noted that the above examples are merely specific implementations of the present specification. Clearly, the present specification is not limited to the above implementations, and many similar changes subsequently occur. All variations directly derived or associated by a person skilled in the art from the content disclosed in the present specification shall fall within the protection scope of the present specification.

The various embodiments described above can be combined to provide further embodiments. All of the U.S. patents, U.S. patent application publications, U.S. patent applications, foreign patents, foreign patent applications listed in the Application Data Sheet are incorporated herein by reference, in their entirety. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A positioning method, comprising:
binding a first device to at least one second device, by a positioning application (APP) of the first device;
scanning, by the first device, a short range wireless signal broadcasted by a second device of the at least one second device;
performing, by the first device, positioning to obtain location information of the first device in response to obtaining the short range wireless signal through the scanning;
uploading, by the first device, the location information to a distributed storage center; and
obtaining, by the positioning APP, the location information from the distributed storage center as location information of the second device.

2. The method according to claim 1, wherein the binding the first device to the at least one second device, by the positioning APP of the first device includes:
performing pairing between the first device and a second device;
after the pairing succeeds, generating, by the positioning APP, a public key and a private key;
storing, by the positioning APP, the private key in the first device, and
sending, by the first device, the public key to the second device for the second device to store the public key.

3. The method according to claim 2, wherein the short range wireless signal includes a device identifier of the second device and the public key.

4. The method according to claim 3, wherein the uploading the location information to the distributed storage center includes:
encrypting, by the first device, the location information by using the public key included in the short range wireless signal, to obtain first encrypted information;
uploading, by the first device, the first encrypted information to a device server of the first device for the device server to
encrypt the first encrypted information by using an encryption key to obtain second encrypted information; and
upload the second encrypted information to the distributed storage center.

5. The method according to claim 4, wherein the obtaining, by the positioning APP, the location information from the distributed storage center includes:
receiving, by the positioning APP, the first encrypted information; and
decrypting, by the positioning APP, the first encrypted information by using the private key stored in the first device, to obtain the location information,
wherein the device server receives the second encrypted information from the distributed storage center and decrypts the second encrypted information by using a decryption key to obtain the first encrypted information.

6. The method according to claim 5, wherein the obtaining the location information from the distributed storage center includes includes:
Querying the second encrypted information in the distributed storage center based on the public key.

7. The method according to claim 3, wherein the uploading, by the first device, the location information to the distributed storage center includes:
encrypting, by the first device, the location information by using the public key included in the short range wireless signal, to obtain first encrypted information;
encrypting, by the first device, the first encrypted information by using an encryption key of a device server of the first device, to obtain second encrypted information; and
uploading, by the first device, the second encrypted information to the distributed storage center.

8. The method according to claim 1, further comprising: after the binding the first device to the at least one second device,
displaying, on a device management interface of the positioning APP, the at least one second device bound to the first device.

9. A device, comprising at least one processor, at least one memory device, and a communication interface, the communication interface configured to exchange information between the device and at least one second device through a short range wireless communication channel, the at least one memory device, individually or collectively, having computer executable instructions stored thereon, which when executed by the at least one processor, enabling the at least one processor to, individually or collectively, implement acts including:
binding the device to the at least one second device;
scanning a short range wireless signal broadcasted by a second device of the at least one second device;
performing positioning to obtain location information of the device in response to obtaining the short range wireless signal through the scanning;
uploading the location information to a distributed storage center; and
obtaining the location information from the distributed storage center as location information of the second device.

10. The device according to claim 9, wherein the binding the device to the at least one second device includes:
performing pairing between the device and a second device;
after the pairing succeeds, generating a public key and a private key;
storing the private key in the device, and
sending the public key to the second device for the second device to store the public key.

11. The device according to claim 10, wherein the short range wireless signal includes a device identifier of the second device and the public key.

12. The device according to claim 11, wherein the uploading the location information to the distributed storage center includes:
encrypting the location information by using the public key included in the short range wireless signal, to obtain first encrypted information; and
uploading the first encrypted information to a device server of the first device for the device server to:
encrypt the first encrypted information by using an encryption key to obtain second encrypted information; and
upload the second encrypted information to the distributed storage center.

13. The device according to claim 12, wherein the obtaining the location information from the distributed storage center includes:
receiving, by the device from the device server from the device server, the first encrypted information; and
decrypting the first encrypted information by using the private key stored in the device to obtain the location information,
wherein the device server receives the second encrypted information from the distributed storage center and decrypts the second encrypted information by using a decryption key to obtain the first encrypted information.

14. The device according to claim 13, wherein the obtaining the location information from the distributed storage center includes:
querying the second encrypted information in the distributed storage center based on the public key.

15. The device according to claim 11, wherein the uploading the location information to the distributed storage center includes:
encrypting the location information by using the public key included in the short range wireless signal, to obtain first encrypted information;
encrypting the first encrypted information by using an encryption key of a device server of the first device, to obtain second encrypted information; and
uploading the second encrypted information to the distributed storage center.

16. The device according to claim 9, wherein the acts include:
after the binding the device to the at least one second device, displaying, on a device management interface of the device, the at least one second device bound to the device.

17. A non-transitory storage medium having computer executable instructions stored thereon, which when executed by at least one processor, enabling the at least one processor to, individually or collectively, implement acts including:
binding a first device to at least one second device;
scanning a short range wireless signal broadcasted by a second device of the at least one second device;
performing positioning to obtain location information of the first device in response to obtaining the short range wireless signal through the scanning;
uploading the location information to a distributed storage center; and
obtaining the location information from the distributed storage center as location information of the second device.

18. The storage medium according to claim 17, wherein the binding the device to the at least one second device includes:
performing pairing between the first device and a second device;
after the pairing succeeds, generating a public key and a private key;
storing the private key in the first device, and
sending the public key to the second device for the second device to store the public key.

19. The storage medium according to claim 18, wherein the short range wireless signal includes a device identifier of the second device and the public key.

20. The storage medium according to claim 19, wherein the uploading the location information to the distributed storage center includes:
encrypting the location information by using the public key included in the short range wireless signal, to obtain first encrypted information; and
encrypt the first encrypted information by using an encryption key of a device server of the first device to obtain second encrypted information; and
uploading the second encrypted information to the distributed storage center.
